(19) United States
(12) Patent Application Publication
(10) Pub. No.: US 2025/0277093 A1
(43) Pub. Date: Sep. 4, 2025

(54) POLYURETHANE COMPOSITE, LAMINATED PRODUCT COMPRISING THE POLYURETHANE COMPOSITE AND PROCESS FOR PRODUCING THE SAME

(71) Applicant: BASF (china) Company Limited, New Area (CN)

(72) Inventors: Guo Dong FU, Shanghai (CN); Shuai Ping GONG, Shanghai (CN); Lei SUN, Shanghai (CN); Xin Gang WANG, Shanghai (CN)

(21) Appl. No.: 18/684,532

(22) PCT Filed: Jun. 6, 2022
(86) PCT No.: PCT/CN2022/097116

§ 371 Date: Feb. 16, 2024

(30) Foreign Application Priority Data
Sep. 9, 2021 (WO) PCT/CN2021/117427

(51) Int. Cl. C08J 5/24; B32B 5/18; B32B 9/00; B32B 9/04; B32B 15/04; C08J 5/04; C08J 5/10; C08K 3/04; C08K 3/32; C08K 3/34; C08K 5/053; C08K 5/3492; C08K 5/521; C08K 13/02; H01M 10/658; H01M 50/28; H01M 50/282

(52) U.S. Cl. CPC C08J 5/244; B32B 5/18; B32B 9/007; B32B 9/046; B32B 15/046; C08J 5/043; C08J 5/10; C08J 5/249; C08K 13/02; H01M 10/658; H01M 50/28; H01M 50/282; B32B 2264/108; B32B 2264/203; B32B 2264/303; B32B 2266/0278; B32B 2307/304; B32B 2307/3065; B32B 2307/718; B32B 2307/7376; B32B 2457/10; C08J 2375/08; C08K 3/04; C08K 2003/323; C08K 3/346; C08K 5/053; C08K 5/34922; C08K 5/521; C08K 2201/014

(57) ABSTRACT

Disclosed herein are a novel polyurethane (PU) composite, a process for producing the PU composite and a covering article containing the PU composite. The PU composite includes 35 to 75 wt % reinforced fiber and 25 to 65 wt % polyurethane foam, based on the total weight of the PU composite, where the reinforced fiber includes 75 to 100 wt % of the reinforced fiber in a continuous phase form and 0 to 25 wt % of the reinforced fiber in a discontinuous phase form, based on the total weight of reinforced fiber. Further disclosed are a laminated product including at least one thermal insulating layer and at least two polyurethane composites arranged on each side of the thermal insulating layer, a process for producing the laminated product and a covering article for battery system containing the laminated product.

### CROSS-REFERENCE TO RELATED APPLICATIONS

This application is a U.S. National Phase Application of International Patent Application No. PCT/CN22/97116, filed Jun. 6, 2022, which claims the benefit of priority to International Application No. PCT/CN21/117427, filed on Sep. 9, 2021, the contents of which are hereby incorporated by reference in their entirety.

### TECHNICAL FIELD

The present invention relates to a novel polyurethane (PU) composite, a process for producing the PU composite and a covering article containing the PU composite. Said PU composite comprises 35 to 75 wt % reinforced fiber and 25 to 65 wt % polyurethane foam, based on the total weight of the PU composite, wherein the reinforced fiber comprises 75 to 100 wt % of the reinforced fiber in a continuous phase form and 0 to 25 wt % of the reinforced fiber in a discontinuous phase form, based on the total weight of reinforced fiber. The present invention further relates to a laminated product comprising at least one thermal insulating layer and a polyurethane composite arranged on each side of the thermal insulating layer, a process for producing the laminated product and a covering article containing the laminated product.

### BACKGROUND

With the development of electric vehicles, more and more attention has been paid to the lightweight design and capacity limits of battery. At present, people mainly use stamped metal sheet as the upper cover of battery pack to protect battery components therein. Although metal materials show good mechanical properties, their density and hence component weight is high; therefore it is urgent to provide a new lightweight, thin and flame retardant component to replace the metal upper cover.

The prior art discloses injection molding part based on polypropylene or polyamide as the upper cover of battery pack. However, it is difficult for such polypropylene or polyamide material injection molding solution to realize a very large size component; the injection molding thereof requires high tooling cost, high injection pressure and temperature. Up to now, there is no publication or patent disclosing or suggesting that spray transfer molding (STM) product or long fiber injection (LFI) product, such as the thus-obtained PU composite, can be used as the upper cover of battery pack.

For example, US2019/0153185A1 discloses a sandwich component comprising a polyurethane foam core and two building material plates, used as non-loading-bearing wall elements, exterior wall cladding, and ceiling elements. Specifically, it discloses that the building plates can further comprise fibers, textiles or reinforcement, which improves the tensile strength of the building material plates. Nevertheless, it fails to disclose or suggest that the polyurethane foam core can be modified and then specifically applied to battery field, for example as an upper cover of battery pack. Furthermore, it is understood by those skilled in the art that the polyurethane foam in the construction field is relatively thick, impeding their use as a thinner upper cover of battery pack.

In addition, the prior art discloses a sheet molding compound (SMC) process for producing a polyurethane foam sheet, which features the impregnation of chopped glass fiber with resin. However, this SMC process usually has the disadvantages of high density, thicker components, uneven distribution of the reinforced glass fiber in final components, and high cost of post-processing steps.

On the other hand, CN 107437631A discloses a battery module comprises a plurality of single batteries, a frame and a protection plate. The protection plate comprises an expandable graphite (EG) plate and an insulation sealing film, wherein the EG plate comprises a substrate formed from an adhesive and EG particles distributed in the substrate, and the sealing film is polyimide (PI) film or polypropylene (PP) film. US20080020270A describes a secondary battery for mobile device which comprises a film (“safety film”) including EG and polyurethane, and also a substrate film selected from polyurethane and polyethylene terephthalate. However, the prior art provided products having only limited EG contents and thus providing limited thermal insulation effect.

Therefore, there is a continuous need to provide a composite that has light weight, reduced thickness, good mechanical property and flame resistance, and at the same time, can be prepared in a cost-efficient way. Moreover, the composite should be easily prepared by using a broad range of raw materials; and to provide a covering article with good electro-magnetic interface (EMI) shielding performance as well as the above-mentioned advantages for the composite. There is also a need to provide a product that has excellent thermal insulation property in addition to the above-mentioned advantages for the composite.

### SUMMARY OF THE PRESENT INVENTION

An object of this invention is to overcome the problem of the prior art discussed above and to provide a composite that has light weight, good mechanical strength, flame resistance and excellent voltage resistance, and at the same time, can be prepared in a cost-efficient way.

Surprisingly, it has been found by the inventors that the above object can be achieved by a polyurethane (PU) composite, comprising 35 to 75 wt % reinforced fiber and 25 to 65 wt % polyurethane foam, based on the total weight of the polyurethane composite, wherein the polyurethane foam is obtained from a two-component reactive system comprising
an isocyanate component consisting of
(a) at least one isocyanate or isocyanate prepolymer, and
a polyol component consisting of
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries,
wherein the reinforced fiber is selected from the group consisting of glass fiber, basalt fiber, carbon fiber and natural fiber; and
wherein the reinforced fiber comprises 75 to 100 wt % of the reinforced fiber in a continuous phase form and 0 to 25 wt % of the reinforced fiber in a discontinuous phase form, based on the total weight of reinforced fiber.

In a further aspect, the invention relates to a process for producing the PU composite as mentioned in the above, wherein the process comprises the following steps:
1) providing a reinforced fiber in a continuous phase form;
2) preparing a polyol component by mixing the following materials in a tank under a temperature of 20 to 80° C.:
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries;
3) mixing the polyol component obtained in step 2) with an isocyanate component and optionally a reinforced fiber in a discontinuous phase form under a temperature of 20 to 80° C. to give a mixture;
4) spraying or injecting the mixture obtained in step 3) onto the reinforced fiber in a continuous phase form provided in step 1) by a first nozzle or an injection head, and optionally spraying reinforced fibers in a discontinuous phase form onto the reinforced fiber in a continuous phase form provided in step 1) by a second nozzle to obtain a sprayed or injected product;
5) hot-pressing the sprayed or injected product obtained in step 4) in a mold which has a temperature of 40 to 180° C. and under a hot press clamping force of 100 to 2000 ton; and
6) demolding and optionally trimming;
the polyurethane composite obtained in step 6) comprises 35 to 75 wt % reinforced fiber and 25 to 65 wt % polyurethane foam, based on the total weight of the polyurethane composite, and
the reinforced fiber comprises 75 to 100 wt % of the reinforced fiber in a continuous phase form and 0 to 25 wt % of the reinforced fiber in a discontinuous phase form, based on the total weight of the reinforced fiber;
the reinforced fiber is selected from the group consisting of glass fiber, basalt fiber, carbon fiber and natural fiber, preferably glass fiber and basalt fiber, and more preferably glass fiber.

It has been surprisingly found in this application that, the PU composite as mentioned above or the PU composite prepared by the process as mentioned above shows reduced weight, good mechanical strength, flame resistance and excellent voltage resistance. Moreover, the process is carried out in a robust and easy way. Correspondingly, the PU composite is obtained cost-effectively.

In a still further aspect, the invention relates to a covering article, comprising at least one PU composite as mentioned above or the PU composite prepared by the process as mentioned above.

Another object of this invention is to provide a laminated product that has light weight, good mechanical strength, flame resistance and good thermal insulation property.

Surprisingly, it has been found by the inventors that this object can be achieved by a laminated product comprising at least one thermal insulating layer and at least two layers of polyurethane composite as described above arranged on each side of the thermal insulating layer; wherein the thermal insulating layer comprises a binder and a thermal insulating material distributed in the binder.

In a further aspect, the invention relates to a process for producing the laminated product as mentioned above, comprising the following steps:
1) providing a thermal insulating layer by
   i) mixing a thermal insulating material with a binder,
   ii) applying the mixture of step i) onto a surface of substrate, and allowing the mixture to cure; and
   iii) optionally removing the substrate;
2) providing a reinforced fiber in a continuous phase form, arranged on each side of the thermal insulating layer obtained in step 1);
3) preparing a polyol component by mixing the following materials in a tank under a temperature of 20 to 80° C.:
   (b) at least one polyol reactive toward isocyanate,
   (c) optionally a chain extender and/or a crosslinking agent,
   (d) a flame retardant,
   (e) optionally a filler,
   (f) a blowing agent,
   (g) a catalyst, and
   (h) optionally additives and/or auxiliaries;
4) mixing the polyol component obtained in step 3) with an isocyanate component and optionally a reinforced fiber in a discontinuous phase form under a temperature of 20 to 80° C. to give a mixture;
5) spraying or injecting the mixture obtained in step 4) onto the reinforced fiber in a continuous phase form arranged on each side of the thermal insulating layer provided in step 2) by a first nozzle or an injection head, and optionally spraying reinforced fibers in a discontinuous phase form onto the reinforced fiber in a continuous phase form provided in step 2) by a second nozzle, to obtain a sprayed or injected product;
6) hot-pressing the sprayed or injected product obtained in step 5) in a mold which has a temperature of 40 to 180° C. and under a hot press clamping force of 100 to 2000 ton; and
7) demolding and optionally trimming, thereby obtaining a laminated product comprising a polyurethane composite arranged on each side of the thermal insulating layer;
wherein the polyurethane composite comprises 35 to 75 wt % reinforced fiber and 25 to 65 wt % polyurethane foam, based on the total weight of the polyurethane composite;
the reinforced fiber comprises 75 to 100 wt % of the reinforced fiber in a continuous phase form and 0 to 25 wt % of the reinforced fiber in a discontinuous phase form, based on the total weight of the reinforced fiber; and
the reinforced fiber is selected from the group consisting of glass fiber, basalt fiber, carbon fiber and natural fiber, preferably glass fiber and basalt fiber, and more preferably glass fiber.

It has been surprisingly found in this application that, the laminated product as mentioned above or the laminated product prepared by the process as mentioned above shows light weight, good mechanical strength, flame resistance, as well as excellent voltage resistance. Moreover, the process is carried out in a robust and easy way. Correspondingly, the laminated product is obtained cost-effectively.

In a still further aspect, the invention relates to a covering article, comprising the laminated product as mentioned above or the laminated product prepared by the process as mentioned above.

### BRIEF DESCRIPTION OF THE FIGURES

FIG. 1 shows the STM process for producing PU composite.

FIG. 2 shows the LFI process for producing PU composite.

FIG. 3 shows a covering article comprising the PU composite and a metal sheet.

FIG. 4 shows a laminated product comprising two PU composite layers and a thermal insulating layer therebetween.

FIG. 5 shows a process for producing thermal insulating layer.

FIG. 6 shows a process for producing the laminated product.

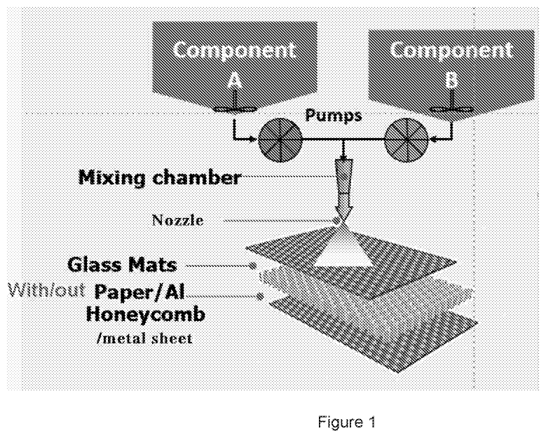

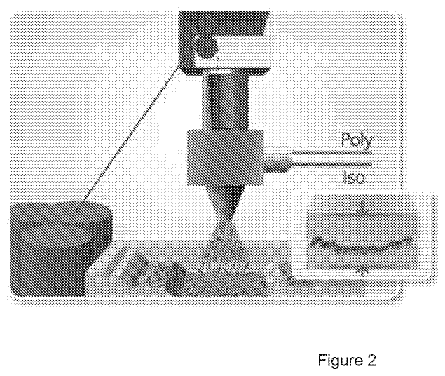

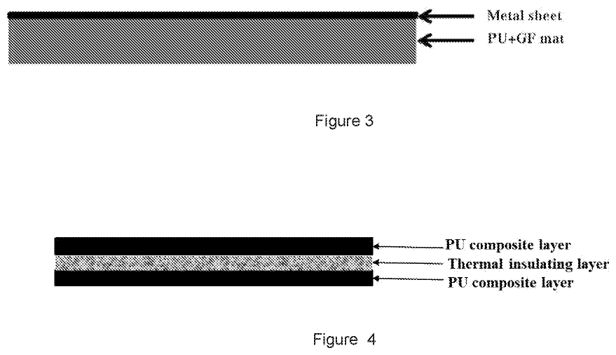

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the expression “comprising” also encompasses the expression “consisting of”.

Unless otherwise identified, all percentages (%) are “percent by weight”.

Unless otherwise identified, the temperature refers to room temperature and the pressure refers to ambient pressure.

As used herein, the term “reinforced fiber in a continuous phase form” refers to such a fiber layer that the fibers comprised in the layer are combined or connected with each other to form an integrated layer.

As used herein, the term “reinforced fiber in a discontinuous phase form” refers to such fibers that are not connected with each other, or are not in a form of an integrated entity.

### I. PU Composite

In an aspect, the invention relates to a polyurethane (PU) composite, wherein the polyurethane composite comprises 35 to 75 wt % reinforced fiber and 25 to 65 wt % polyurethane foam, based on the total weight of the polyurethane composite, wherein the polyurethane foam is obtained from a two-component reactive system comprising
an isocyanate component, consisting of
(a) at least one isocyanate or isocyanate prepolymer, and
a polyol component, consisting of
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries,
wherein the reinforced fiber is selected from the group consisting of glass fiber, basalt fiber, carbon fiber and natural fiber, preferably glass fiber and basalt fiber, and more preferably glass fiber; and
wherein the reinforced fiber comprises 75 to 100 wt % of the reinforced fiber in a continuous phase form and 0 to 25 wt % of the reinforced fiber in a discontinuous phase form, based on the total weight of reinforced fiber.

In an embodiment, the reinforced fiber is impregnated with polyurethane foam.

In an embodiment, the reinforced fiber in a continuous phase form is in a form of mat, woven fabrics, or combinations thereof. In a specific embodiment, the reinforced fiber in a continuous phase form is assembled rovings E512 commercially available from China Jushi Co. Ltd. In the present application, the term “mat” means a material which is in a form of felt, thin cloth, relatively thin sheet, knit-like or the like. In an embodiment, the mat is formed by a process known in the art, such as a conventional process with warp and weft yarn or electrospinning process. On these bases, it will be appreciated that the reinforced fiber in a continuous phase form may be in the form of veil mats, chopped strand mat, woven fabrics, non-woven fabrics, fiber cloths, stitch mat, etc.

In an embodiment, the reinforced fiber in a continuous phase form has a density of from 200 to 1600 gram per square meter, preferably from 400 to 900 gram per square meter.

In an embodiment, the PU composite comprises 1 layer to 4 layers of the mat, woven fabrics, or combinations thereof, preferably 1 layer to 4 layers of the reinforced fiber mat in a continuous phase form, for example 1, 2, 3, or 4 layer(s).

In an embodiment, the PU composite comprises reinforced fiber in a discontinuous phase form. In an embodiment, the reinforced fiber in a discontinuous phase form has a length of 6 to 100 mm, preferably 8 to 80 mm, more preferably 10 to 50 mm, and even more preferably 12 to 25 mm. In a specific embodiment, the reinforced fiber in a discontinuous phase form is assembled rovings E440 commercially available from China Jushi Co. Ltd.

In an embodiment, the PU composite has a density of less than 2.2 g/cm³, preferably less than 1.8 g/cm³, preferably less than 1.6 g/cm³, more preferably less than 1.5 g/cm³, and even more preferably less than 1.3 g/cm³, and most preferably less than 1.2 g/cm³.

In an embodiment, the PU composite is made in the form of sheet having a thickness of 0.5 to 10 mm, preferably 1 to 5 mm, more preferably 1 to 3 mm, and even more preferably 1 to 2 mm.

In an embodiment, the polyurethane composite comprises flame retardant (d) selected from the group consisting of expandable graphite, red phosphorus, ammonium polyphosphate, triethyl phosphate, tris(2-clorisopropyl)phosphate, melamine, expandable graphite (EG), red phosphorus, ammonium polyphosphate, tris(1-chloro-2-propyl)phosphate (TCPP), triethyl phosphate (TEP), chlorine and bromine containing polyols, such as epichlorohydrin, chlorendic anhydride and trichlorobutylene oxide (TCBO), phosephorus containing polyols, such as esters of ortho-phosphori acid, esters of phosphorus acid, phosphanate polyols, phosphine oxide polyols and phosphoramidic polyols.

In an embodiment, the PU composite has a tensile strength of at least 90 MPa, preferably at least 95 MPa, more preferably at least 100 MPa, even more preferably at least 120 MPa, and most preferably at least 130 MPa, determined according to GB/T1447-2005.

In an embodiment, the PU composite has a flexural strength of at least 180 MPa, preferably at least 185 MPa, more preferably at least 190 MPa, even more preferably at least 200 MPa, and most preferably at least 230 MPa, determined according to GB/T1449-2005.

In an embodiment, the PU composite passes the UL94 V0 grade for fire test. In an embodiment, the PU composite passes UL 94 5VA fire test.

### Polyurethane

In preparing the PU composite, “isocyanate component” and “polyol component” (also referred to as “resin component” or “resin” in the following) are used, with “polyol component” being a mixture of a polyol reactive toward isocyanate (b), optionally a chain extender and/or a crosslinking agent (c), a flame retardant (d), optionally a filler (e), a blowing agent (f), a catalyst (g), and optionally auxiliaries and additives (h), and “isocyanate component” being at least one isocyanate or isocyanate prepolymer (a).

The polyol components react with the isocyanate to form urethane linkages. Such systems are disclosed, for example, in U.S. Pat. No. 4,218,543.

It is noted that, in the present application, the polyol components do not include the reinforced fiber, i.e., reinforced fibers in continuous form and discontinuous form.

In a preferred embodiment, the “isocyanate component” and “polyol component” are impingement mixed, and sprayed or injected at about atmospheric pressure into a mold which is subsequently closed. The mold is preheated at from 40 to 180° C., preferably 70 to 150° C., and more preferably 90 to 130° C., and optionally contain an insert (such as metal sheet, metal foil, or solid flame retardant layer) on the mold surface. The raw materials are sprayed or injected uniformly over the fiber fabrics in the mold, after which the molded part is demolded after a period of typically 1 to 15 min, preferably 90 s to 10 min, and more preferably 2 to 8 min.

### Isocyanate or Isocyanate Prepolymer (a)

Isocyanate component used for producing the polyurethanes of the invention comprise any of isocyanates known for producing polyurethanes. These comprise aliphatic, cycloaliphatic, araliphatic and/or aromatic isocyanates, such as tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and/or dicyclohexylmethane 4,4′-, 2,4′- and 2,2′-diisocyanate, diphenylmethane 2,2′-, 2,4′- and/or 4,4′-diisocyanate (MDI), polymeric MDI, naphthylene 1,5-diisocyanate (NDI), tolylene 2,4- and/or 2,6-diisocyanate (TDI), 3,3′-dimethyl diphenyl diisocyanate, 1,2-diphenylethane diisocyanate and/or phenylene diisocyanate. Particular preference is given to using 2,2′-, 2,4′- and/or 4,4′-diisocyanate, and polymeric MDI.

Other possible isocyanates are given by way of example in “Kunststoffhandbuch, Band 7, Polyurethane” [Plastics handbook, volume 7, Polyurethanes], Carl Hanser Verlag, 3rd edition, 1993, chapters 3.2 and 3.3.2.

Besides, isocyanate component may also be used in the form of an isocyanate prepolymer. The isocyanate prepolymer is obtainable by reacting the isocyanate described above with an additional polyol (a′), for example, at a temperature of from 30 to 100° C., preferably about 80° C. Preference is given to 4,4′-MDI together with uretonimine-modified MDI and commercial polyols based on polyesters, for example ones derived from adipic acid or polyethers, for example ones derived from ethylene oxide and/or propylene oxide, for producing the prepolymers employed according to the invention. Preference is given to 4,4′-MDI and polyols derived from ethylene oxide and/or propylene oxide, for producing the prepolymers employed according to the invention.

The additional polyol (a′) is known to those skilled in the art and described by way of example in “Kunststoffhandbuch [Plastics handbook], Volume 7, Polyurethane [Polyurethanes]”, Carl Hanser Verlag, 3rd Edition 1993, chapter 3.1.

Prepolymers based on ethers are preferably obtained by reacting isocyanates, particularly preferably 4,4′-MDI, with 2- to 3-functional polyoxypropylene polyols and/or polyoxypropylene-polyoxyethylene polyols. They are usually prepared by the generally known base-catalyzed addition of propylene oxide alone or in admixture with ethylene oxide onto H-functional, in particular OH-functional, starter substances. Starter substances employed are, for example, water, ethylene glycol or propylene glycol and also glycerol or trimethylolpropane. Furthermore, multimetal cyanide compounds, known as DMC catalysts, can also be used as catalysts. For example, polyethers as described below under component (b) can be used as the additional polyols (a′).

When ethylene oxide/propylene oxide mixtures are used, the ethylene oxide is preferably used in an amount of 10-50 wt. %, based on the total amount of alkylene oxide. The alkylene oxides can be incorporated blockwise or as a random mixture. Particular preference is given to incorporation of an ethylene oxide end block (“EO cap”) in order to increase the content of more reactive primary OH end groups. The number average molecular weight of the polyols (a′) is preferably in the range from 1750 to 5500 g/mol.

If appropriate, customary chain extenders or crosslinking agents are added to the additional polyols mentioned in the preparation of the isocyanate prepolymers.

Customary chain extenders or crosslinking agents can be the same as those described below under c). Particular preference is given to using dipropylene glycol, tripropylene glycol or monoethylene glycol (MEG) as chain extenders or crosslinking agents.

### Polyol Reactive Toward Isocyanate (b)

Polyol reactive toward isocyanate (b) can be any of the polyols useful for polyurethane production in the art and having at least two reactive hydrogen atoms. By way of example, it is possible to use polyether polyamines and/or polyols selected from the group of the polyether polyols and polyester polyols, or a mixture thereof.

The polyols preferably used are polyether polyols with a weight average molecular weight from 200 to 10,000, preferably from 300 to 8000, more preferably from 500 to 6000, and most preferably from 2500 to 3500, and a OH value from 20 to 1200 mg KOH/g, preferably from 30 to 1000 mg KOH/g, more preferably from 40 to 500; and/or polyester polyols with a molecular weight between 350 and 2000, preferably from 350 to 650, and a OH value between 60 and 650 mg KOH/g, preferably from 120 to 310 mg KOH/g. The following polyols are preferred in the invention: LUPRANOL® 2095 (BASF), LUPRANOL® 2090 (BASF), LUPRANOL 3505/1 (BASF), LUPRAPHEN® 3905 (BASF), LUPRAPHEN® 3907 (BASF), LUPRAPHEN® 3909 (BASF), STEPANPOL® PS 3152, PS 2412, PS 1752, CF 6925 (Stepan Company).

The polyether polyols used in the invention can be produced by known processes. By way of example, they can be produced from one or more alkylene oxides having from 2 to 4 carbon atoms in the alkylene radical via anionic polymerization using alkali metal hydroxides, such as sodium hydroxide or potassium hydroxide, or using alkali metal alcoholates, such as sodium methoxide, sodium ethoxide or potassium ethoxide, or potassium propoxide as catalysts, with addition of at least one starter molecule which comprises from 2 to 8 reactive hydrogen atoms, or via cationic polymerization using Lewis acids, such as antimony pentachloride, boron fluoride etherate, etc., or bleaching earth as catalysts.

Examples of suitable alkylene oxides are tetrahydrofuran, propylene 1,2-oxide, butylene 1,2-oxide or butylene 2,3-oxide, styrene oxide, and preferably ethylene oxide and propylene 1,2-oxide. The alkylene oxides can be used individually, in alternating succession, or as a mixture.

Examples of starter molecules that can be used are: water, organic dicarboxylic acids, such as succinic acid, adipic acid, phthalic acid, and terephthalic acid, aliphatic and aromatic, optionally N-mono-, N, N-, and N,N′-dialkyl-substituted diamines having from 1 to 4 carbon atoms in the alkyl radical, e.g. optionally mono- and dialkyl-substituted ethylenediamine, diethylenetriamine, triethylenetetramine, 1,3-propylenediamine, 1,3- or 1,4-butylenediamine, 1,2-, 1,3-, 1,4-, 1,5-, and 1,6-hexamethylenediamine, phenylenediamines, 2,3-, 2,4-, and 2,6-tolylenediamine, and 4,4′-, 2,4′-, and 2,2′-diaminodiphenylmethane.

Polyester polyols can by way of example be produced from dicarboxylic acids having from 2 to 12 carbon atoms, preferably from 4 to 6 carbon atoms, and from polyhydric alcohols. Examples of dicarboxylic acids that can be used are: aliphatic dicarboxylic acids, such as succinic acid, glutaric acid, adipic acid, suberic acid, azelaic acid, and sebacic acid, and aromatic dicarboxylic acids, such as phthalic acid, isophthalic acid, and terephthalic acid. The dicarboxylic acids can be used individually or in the form of mixtures, e.g. in the form of a mixture of succinic, glutaric, and adipic acid. Examples of polyhydric alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol, triols having from 3 to 6 carbon atoms, e.g. glycerol and trimethylolpropane, and, as higher-functionality alcohol, pentaerythritol. The polyhydric alcohols can be used alone or optionally in mixtures with one another, in accordance with the properties desired.

The amount of polyether polyol and/or polyester polyol, based on the total weight of the resin, is preferably from 0 to 40% by weight, particularly preferably from 15 to 35% by weight.

Chain Extender and/or Crosslinking Agent (c)

Chain extenders and/or crosslinking agents (c) that can be used are substances having a molar mass which is preferably smaller than 500 g/mol, particularly preferably from 60 to 400 g/mol, wherein chain extenders have 2 hydrogen atoms reactive toward isocyanates and crosslinking agents have 3 hydrogen atoms reactive toward isocyanate. These can be used individually or preferably in the form of a mixture. It is preferable to use diols and/or triols having molecular weights smaller than 500, particularly from 60 to 400, and in particular from 60 to 350. Examples of those that can be used are aliphatic, cycloaliphatic, and/or araliphatic diols having from 2 to 14, preferably from 2 to 10, carbon atoms, e.g. ethylene glycol, 1,3-propanediol, 1,4-butanediol, 1,6-hexanediol, 1,10-decanediol, 1,2-, 1,3-, and 1,4-dihydroxycyclohexane, diethylene glycol, dipropylene glycol, tripropylene glycol, diethanolamine, or triols, e.g. 1,2,4- or 1,3,5-trihydroxycyclohexane, glycerol, and trimethylolpropane. Chain extenders and/or crosslinking agents (c) are preferably selected from ethylene glycol, diethylene glycol, dipropylene glycol, tripropylene glycol and glycerin.

The amount of chain extender and/or crosslinking agent c), if present, is preferably from 0 to 50% by weight, particularly preferably from 10 to 40% by weight, based on the total weight of the resin.

### Flame Retardant (d)

Flame retardants (d) that can be used are additive flame retardants and reactive flame retardants, or the combination thereof. Additive flame retardants are monomer molecules that are not chemically bound to the polymer. The additive flame retardants may in the form of solid flame retardants, liquid flame retardants, or the combination thereof. The commercialized additive flame retardants are tris(2-clorisopropyl)phosphate, melamine, expandable graphite (EG), red phosphorus, ammonium polyphosphate, tris(1-chloro-2-propyl)phosphate (TCPP), triethyl phosphate (TEP). The reactive flame retardants are generally polyols containing halogens and/or phosphorus. The flame retardant polyols have terminal hydroxyl groups which may react with poly-isocyanates in the PU synthesis. The halogen containing FR polyols may be chlorine and bromine containing polyols, such as epichlorohydrin, chlorendic anhydride and trichlorobutylene oxide (TCBO); phosephorus containing polyols, such as esters of ortho-phosphori acid, esters of phosphorus acid, phosphanate polyols, phosphine oxide polyols, phosphoramidic Polyols.

For the purpose of flame resistance, the total amount of flame retardants is preferably in the range of 5 to 30 wt %, more preferably 10 to 25 wt %, based on the total weight of the resin.

### Filler (e)

Fillers that can be used are the usual organic or inorganic fillers known per se. Individual examples which may be mentioned are: inorganic fillers, such as silicate minerals, metal oxides, such as alumina, titanium oxides and iron oxides. In the present application, the filler has an average particle size of less than 600 μm, preferably less than 500 μm, and more preferably less than 400 μm. Filler (e) is preferably selected from titanium oxide and iron oxides.

The amount of filler is from 0 to 30% by weight, preferably from 0 to 15% by weight, based on the total weight of resin. The weight ratio of flame retardant (d) and filler (e) is in a range of from 0.1 to 10, preferably 0.5 to 2.

The fillers may serve to reduce the coefficient of thermal expansion of the polyurethane foam, which is greater than that of metal, for example, and thus to match this coefficient to that of the metal. This is particularly advantageous for a durably strong bond between metal sheets and polyurethane core layer, since it results in lower stresses between the layers when they are subjected to thermal load.

In the present application, the filler (e) does not include the reinforced fiber, i.e., reinforced fibers in continuous form and discontinuous form. In other words, the polyol component does not include the reinforced fiber, i.e., reinforced fibers in continuous form and discontinuous form.

### Blowing Agent (f)

The blowing agent (f) used according to the invention preferably comprises water. The blowing agent (f) used can also comprise, as well as water, other chemical and/or physical blowing agents in the art. Chemical blowing agents are compounds which form gaseous products through reaction with isocyanate, an example being water or formic acid. Physical blowing agents are compounds which have been dissolved or emulsified in the starting materials for polyurethane production and which vaporize under the conditions of polyurethane formation. By way of example, these are hydrocarbons, halogenated hydrocarbons, and other compounds, such as perfluorinated alkanes, e.g. perfluorohexane, fluorochlorocarbons, and ethers, esters, ketones and/or acetals. In one preferred embodiment, water is used as sole blowing agent (f). In this case, the polyurethane foam according to the invention is water-blown polyurethane spray foam. Concerning water, there is no particular limitation. Mineral water, deionized water or tapwater can be used.

The amount of blowing agent is from 0 to 5% by weight, preferably from 0.1 to 3% by weight, based on the total weight of the resin.

### Catalyst (g)

As catalyst (g), it is possible to use any of compounds which accelerate the isocyanate-polyol reaction. Such compounds are known and are described, for example, in “Kunststoffhandbuch, volume 7, Polyurethane”, Carl Hanser Verlag, 3rd edition 1993, chapter 3.4.1. These comprise amine-based catalysts and catalysts based on organic metal compounds.

As catalysts based on organic metal compounds, it is possible to use, for example, organic tin compounds such as tin (II) salts of organic carboxylic acids, e.g. tin (II) acetate, tin (II) octoate, tin (II) ethylhexanoate and tin (II) laurate, and the dialkyltin (IV) salts of organic carboxylic acids, e.g. dibutyltin diacetate, dibutyltin dilaurate, dibutyltin maleate and dioctyltin diacetate, and also bismuth carboxylates, e.g. bismuth (III) neodecanoate, bismuth 2-ethylhexanoate and bismuth octanoate, or alkali metal salts of carboxylic acids, e.g. potassium acetate or potassium formate.

Preference is given to using amine-based catalysts as catalyst (g), such as N,N,N′,N′-tetramethyldipropylenetriamine, 2-[2-(dimethylamino)ethyl-methylamino]ethanol, N,N,N′-trimethyl-N′-2-hydroxyethyl-bis-(aminoethyl) ether, bis(2-dimethylaminoethyl) ether, N,N,N,N,N-pentamethyldiethylenetriamine, N,N,N-triethylaminoethoxyethanol, dimethylcyclohexylamine, trimethyl hydroxyethyl ethylenediamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl) hexahydrotriazine, dimethylaminopropylamine, N-ethylmorpholine, diazabicycloundecene and diazabicyclononene. Here, examples which may be mentioned are Jeffcat ZF 10 (CAS No. 83016-70-0), Jeffcat DMEA (CAS No. 108-01-0) and Dabco T (CAS No. 2212-32-0). This kind of reactive catalyst has an effect of reducing VOC value.

The amount of catalyst (g), based on the total weight of the resin, is preferably from 0.1 to 5% by weight, particularly preferably from 0.1 to 3.5% by weight.

Additives and/or Auxiliaries (h)

Additives and/or auxiliaries (h) that can be used comprise, but are not limited to, surfactants, preservatives, colorants, antioxidants, reinforcing agents, stabilizers, and water absorbent. In preparing polyurethane foam, it is generally highly preferred to employ a minor amount of a surfactant to stabilize the foaming reaction mixture until it cures. Such surfactants advantageously comprise a liquid or solid organosilicone surfactant, which is employed in amounts sufficient to stabilize the foaming reaction mixture. Typically, the amount of auxiliaries, especially surfactants, is preferably from 0 to 15% by weight, more preferably from 0.5 to 6% by weight, based on the total weight of the resin.

Further information concerning the mode of use and of action of the abovementioned auxiliaries and additives, and also further examples, are given by way of example in “Kunststoffhandbuch, Band 7, Polyurethane” [“Plastics handbook, volume 7, Polyurethanes”], Carl Hanser Verlag, 3rd edition 1993, chapter 3.4.

The weight ratio of the polyol component and the isocyanate component is in a range of from 1:0.6 to 1:2, preferably 1:0.7 to 1:1

### Process for Producing the PU Composite

In a further aspect, the invention relates to a process for producing the PU composite as mentioned above, wherein the process comprises the following steps:
1) providing a reinforced fiber in a continuous phase form;
2) preparing a polyol component by mixing the following materials in a tank under a temperature of 20 to 80° C.:
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries;
3) mixing the polyol component obtained in step 2) with an isocyanate component and optionally a reinforced fiber in a discontinuous phase form under a temperature of 20 to 80° C. to give a mixture;
4) spraying or injecting the mixture obtained in step 3) onto the reinforced fiber in a continuous phase form provided in step 1) by a first nozzle or an injection head, and optionally spraying reinforced fibers in a discontinuous phase form onto the reinforced fiber in a continuous phase form provided in step 1) by a second nozzle to obtain a sprayed or injected product;
5) hot-pressing the sprayed or injected product obtained in step 4) in a mold which has a temperature of 40 to 180° C. and under a hot press clamping force of 100 to 2000 ton; and
6) demolding and optionally trimming;
wherein the polyurethane composite obtained in step 6) comprises 35 to 75 wt % reinforced fiber and 25 to 65 wt % polyurethane foam, based on the total weight of the polyurethane composite, and
the reinforced fiber comprises 75 to 100 wt % of the reinforced fiber in a continuous phase form and 0 to 25 wt % of the reinforced fiber in a discontinuous phase form, based on the total weight of the reinforced fiber;
the reinforced fiber is selected from the group consisting of glass fiber, basalt fiber, carbon fiber and natural fiber, preferably glass fiber and basalt fiber, and more preferably glass fiber.

In an embodiment, the total amount of the reinforced fibers in a continuous phase form and optionally the reinforced fibers in a discontinuous phase form used in steps 1), 3) and 4) and the total amount of the polyol component and the isocyanate component used in step 3) is in a ratio by weight of about (35˜75):(25˜65).

In an embodiment, the reinforced fiber in a discontinuous phase form in step 3) is obtained by chopping long fibers on site, and is added into the mixture of the isocyanate component and the polyol component of polyurethane in a constant rate, and the chopped reinforced fiber has a length of 6 to 100 mm, preferably 8 to 80 mm, more preferably 10 to 50 mm, and even more preferably 12 to 25 mm.

In an embodiment, the reinforced fiber in a continuous phase form in step 1) is in a form of mat, woven fabrics, or combinations thereof.

### Spray Transfer Molding (STM) Process

In an aspect, the present invention provides a spray transfer molding (STM) process for producing the PU composite as mentioned above, comprising the following steps:
1) providing a reinforced fiber in a continuous phase form;
2) preparing a polyol component by mixing the following materials in a tank under a temperature of 20 to 80° C.:
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries;
3) mixing the polyol component obtained in step 2) with an isocyanate component under a temperature of 20 to 80° C. to give a mixture;
4) spraying the mixture obtained in step 3) onto the reinforced fiber in a continuous phase form provided in step 1) by a first nozzle, and optionally spraying reinforced fibers in a discontinuous phase form onto the reinforced fiber in a continuous phase form provided in step 1) by a second nozzle to obtain a sprayed product;
5) hot-pressing the sprayed product obtained in step 4) in a mold which has a temperature of 40 to 180° C. and under a hot press clamping force of 100 to 2000 ton; and
6) demolding and optionally trimming;
wherein the polyurethane composite obtained in step 6) comprises 35 to 75 wt % reinforced fiber and 25 to 65 wt % polyurethane foam, based on the total weight of the polyurethane composite;
the reinforced fiber comprises 75 to 100 wt % of the reinforced fiber in a continuous phase form and 0 to 25 wt % of the reinforced fiber in a discontinuous phase form, based on the total weight of the reinforced fiber; and the reinforced fiber is selected from the group consisting of glass fiber, basalt fiber, carbon fiber and natural fiber, preferably glass fiber and basalt fiber, and more preferably glass fiber.

In an embodiment, the process comprises, in step 1), providing 1 layer to 4 layers of reinforced fiber in a continuous phase form, for example 1, 2, 3 or 4 layer(s).

In an embodiment, in step 1), the open mold is pre-heated at a temperature of 40 to 180° C., preferably 70 to 150° C., and more preferably 90 to 130° C.

In an embodiment, in step 4), the first nozzle is used to spray the mixture obtained in step 3) onto the reinforced fiber layer(s). In an embodiment, in step 4), the first nozzle moves in such a speed that the resulting PU composite is relatively thin, for example, of a thickness of 0.5 to 10 mm, preferably 1 to 5 mm, more preferably 1 to 3 mm, and even more preferably 1 to 2 mm.

In an embodiment, in step 4), the spraying the mixture is carried out with the first nozzle transferring continuously from one edge to another over two surfaces of the reinforced fiber layer. In this embodiment, the spraying can be carried out over the first surface of the reinforced fiber layer, and then the PU with the reinforced fiber layers is picked up, turned over and laid down in succession, and then the spraying is carried out over the second surface of the reinforced fiber layer.

In another embodiment, in step 4), the spraying the mixture is carried out over one surface of the reinforced fiber layer.

In a preferred embodiment, the process comprises, in step 4), spraying reinforced fibers in a discontinuous phase form onto the reinforced fiber layer(s) using the second nozzle. In this embodiment, the spraying reinforced fibers in a discontinuous phase form may be carried out on the whole area or partial area of the target composite as desired. In this embodiment, the discontinuous reinforced fibers are sprayed at the same time with the spraying of the mixture obtained in step 3). Thus, the discontinuous reinforced fibers can be arranged and distributed into the mixture obtained in step 3).

In an embodiment, the total amount of the reinforced fibers in a continuous phase form and optionally the reinforced fibers in a discontinuous phase form used in steps 1) and 4) and the total amount of the polyol component and the isocyanate component used in step 3) is in a ratio by weight of about (35˜75):(25˜65).

In a specific embodiment, the reinforced fiber comprises 100 wt % of the reinforced fiber in a continuous phase form, based on total weight of the reinforced fiber.

In an embodiment, in step 5), the mold is closed and kept for 1 to 15 min, preferably 90 s to 10 min, and more preferably 2 to 8 min.

In an embodiment, in step 5), the mold is closed and kept at a temperature of 40 to 180° C., preferably 70 to 150° C., and more preferably 90 to 130° C. In an embodiment, in step 5), the mold is closed and kept under a hot press clamping force of 100 to 2000 ton, preferably 200 to 1500 ton, and more preferably 300 to 1000 ton.

In an embodiment, the PU composites may optionally be produced as containing at least one insert such as metal sheet, metal foil, or solid flame retardant layer. In one embodiment, a covering article comprising the PU composite and at least one metal sheet is obtained. In another embodiment, a covering article comprising the PU composite and a layer of solid flame retardant is obtained.

In an embodiment, in step 6), the trimming step is carried out at the same time of demolding, with a knife designed on the mold for cutting trimmings in the STM process.

In this embodiment, a device used in this STM process is designed with a knife on the mold for cutting trimmings. Long fiber injection (LFI) process

In another aspect, the present invention further provides a long fiber injection (LFI) process for producing the PU composite as mentioned above, comprising the following steps:
1) providing a reinforced fiber in a continuous phase form;
2) preparing a polyol component by mixing the following materials in a tank under a temperature of 20 to 80° C.:
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries;
3) mixing the polyol component obtained in step 2) with an isocyanate component and a reinforced fiber in a discontinuous phase form under a temperature of 20 to 80° C. to give a mixture;
4) injecting the mixture obtained in step 3) onto the reinforced fiber in a continuous phase form provided in step 1) by an injection head to obtain an injected product;
5) hot-pressing the injected product obtained in step 4) in a mold which has a temperature of 40 to 180° C. and under a hot press clamping force of 100 to 2000 ton; and
6) demolding and optionally trimming;
wherein the polyurethane composite obtained in step 6) comprises 35 to 75 wt % reinforced fiber and 25 to 65 wt % polyurethane foam, based on the total weight of the polyurethane composite;
the reinforced fiber comprises 75 to <100 wt % of the reinforced fiber in a continuous phase form and >0 to 25 wt % of the reinforced fiber in a discontinuous phase form, based on the total weight of the reinforced fiber;
the reinforced fiber is selected from the group consisting of glass fiber, basalt fiber, carbon fiber and natural fiber, preferably glass fiber and basalt fiber, and more preferably glass fiber.

In an embodiment, the process comprises, in step 1), providing 1 layer to 4 layers of reinforced fiber in a continuous phase form, for example 1, 2, 3, or 4 layer(s).

In an embodiment, in step 1), the open mold is pre-heated at a temperature of 40 to 180° C., preferably 70 to 150° C., and more preferably 90 to 130° C.

In an embodiment, in step 3), the mixing is carried out immediately before the injection, in a mixing chamber.

In an embodiment, in step 3), the reinforced fiber in a discontinuous phase form is obtained by chopping long fibers on site, immediately before the mixing chamber, and is added into the mixture of the isocyanate component and the polyol component (i.e., into the mixing chamber) at a constant rate. In this embodiment, the reinforced fiber before chopping is in a form of fiber coil, which is winded around a bobbin.

In an embodiment, the reinforced fiber is added at such a rate that the resulting PU composition has a fiber content of from 35 to 75 wt % reinforced fiber, based on the total weight of the PU composite.

In an embodiment, the total amount of the reinforced fibers in a continuous phase form and the reinforced fibers in a discontinuous phase form used in steps 1) and 3) and the total amount of the polyol component and the isocyanate component used in step 3) is in a ratio by weight of about (35˜75):(25˜65).

In an embodiment, in step 3), the reinforced fiber in a discontinuous phase form has a length of has a length of 6 to 100 mm, preferably 8 to 80 mm, more preferably 10 to 50 mm, and even more preferably 12 to 25 mm.

In an embodiment, in step 4), an injection head is used to inject the mixture obtained in step 3) onto the surface of the reinforced fiber layer in an open mold.

In an embodiment, in step 5), the mold is closed and kept at a temperature of 40 to 180° C., preferably 70 to 150° C., and more preferably 90 to 130° C. In an embodiment, in step 5), the mold is closed and kept under a hot press clamping force of 100 to 2000 ton, preferably 200 to 1500 ton, and more preferably 300 to 1000 ton. In an embodiment, in step 5), the mold is closed and kept for 1 to 15 min, preferably 90 s to 10 min, and more preferably 2 to 8 min.

In an embodiment, the PU composites may optionally be produced as containing at least one insert such as metal sheet, metal foil, or solid flame retardant layer. In one embodiment, a covering article comprising the PU composite and at least one metal sheet is obtained. In another embodiment, a covering article comprising the PU composite and at least one metal foil is obtained.

In an embodiment, in step 6), the trimming step is carried out at the same time of demolding, with a knife designed on the mold for cutting trimmings in the LFI process. In this embodiment, a device used in this LFI process is designed with a knife on the mold for cutting trimmings.

Surprisingly, the inventors found that all above processes allow to prepare PU composites with a thickness of 0.5 to 10 mm, preferably 1 to 5 mm, more preferably 1 to 3 mm, and even more preferably 1 to 2 mm, and a reduced density, for example a density of less than 1.8 g/cm³, preferably less than 1.6 g/cm³, more preferably less than 1.5 g/cm³, and even more preferably less than 1.3 g/cm³, and most preferably less than 1.2 g/cm³. Moreover, they have the advantages of less requirement for the raw materials, good impregnation between fibers and PU, low cost, short cycle time, etc.

Furthermore, the relatively low pressure and temperature requirements for STM and LFI processes translate to lower tooling cost. In addition, STM and LFI can successfully mold complex parts with high resolution features containing thick and thin walls.

### Covering Article

In one aspect, the present invention provides a covering article, comprising at least one polyurethane composite as mentioned above or the polyurethane composite obtained by the process as mentioned above.

In an embodiment, the covering article has a thickness between 1 and 5 mm, preferably between 1.2 and 3 mm.

In an embodiment, the covering article further comprises at least one metal sheet located on at least one side of the at least one PU composite sheet. In a preferred embodiment, the covering article comprises two metal sheets located on both sides of the PU composite sheet. In this embodiment, the covering article contains a PU composite sheet as a core layer and two metal sheets located on both sides of the core layer, forming a sandwich-like structure. In another preferred embodiment, the covering article comprises one metal sheet located one side of the PU composite sheet. In some alternative embodiments, the covering article comprises one metal sheet and two PU composite sheets located on both sides of the metal sheet. In an embodiment, the metal sheet is independently selected from aluminum alloy, iron, steel and aluminum sheet.

The metal sheet may have a thickness of between 0.08 and 1.2 mm, preferably between 0.08 and 0.6 mm, more preferably between 0.12 and 0.4 mm, and most preferably between 0.2 and 0.3 mm.

In a preferable embodiment, the metal sheet has a thickness of between 0.2 and 1.2 mm, preferably between 0.5 and 1.0 mm. It has been found that the metal sheet in such a thickness advantageously provides improved mechanical strength, which enables covering articles with such metal sheets further meet mechanical strength requirements.

The covering article according to the invention can be used as upper cover of a battery pack.

The covering article according to the invention has good fire performance, electro-magnetic interface (EMI) shielding performance, excellent electrical insulating property and voltage resistance, suitable for use as upper cover of a battery pack. Besides, the covering article according to the invention passes UL94 V0 grade at a thickness of 2 mm. A battery pack containing the covering article according to the invention as upper cover passes the external fire burning test, according to GB 38031-2020.

The covering article according to the invention further has good shielding efficiency (SE). In an embodiment, the covering article shows a shielding ratio (dB) of at least 40, preferably at least 50, more preferably at least 60. A dB value is calculated by the formula of [dB]=20×log (E0/E1), wherein E0 represents the field strength without the covering article, and E1 represents the field strength with the covering article. For instance, a dB value of 60 indicates that the covering article reflects and/or absorbs 99.9% of the electromagnetic energy.

### II. Laminated Product

In an aspect, the invention relates to a laminated product comprising at least one thermal insulating layer and at least two layers of PU composite arranged on each side of the thermal insulating layer,
wherein the thermal insulating layer comprises a binder and a thermal insulating material distributed in the binder.

As shown in FIG. 4, the laminated product includes one two PU composite layers and one thermal insulating layer placed in-between the two PU composite layers.

It is noted that, the PU composite comprised in the laminated product has the same meaning as described in the “PU composite” part or the PU composite prepared according to the “Process for producing the PU composite” part in the above (see section I. PU composite), unless otherwise stated. For brevity, they are not repeated here.

In an embodiment, the thermal insulating layer comprises 10 wt % to 70 wt %, preferably 20 wt % to 50 wt %, more preferably 20 wt % to 40 wt % of the thermal insulating material, based on the total weight of the thermal insulating layer. Alternatively, the thermal insulating layer has a surface density of 50-500 g/m², 50-200 g/m², 100-200 g/m². It is understood that surface density refers to the mass of materials (g) per square meters. When weight percentage/surface density of the thermal insulating material is too high, it is not easy for the thermal insulating material to bond together and form a film; meanwhile, when the weight percentage/surface density of the thermal insulating material is too low, corresponding thermal insulating property cannot be achieved.

In an embodiment, the thermal insulating layer is intumescent thermal insulating layer, and the thermal insulating material is intumescent thermal insulating material.

The intumescent thermal insulating material releases nonflammable gas (like SO₂, CO₂, ammonia and etc.) and/or water vapor when exposed to high temperature, and then swells to form carbon foam layer. The released nonflammable gas and/or water vapor dilute surrounding oxygen density and thereby reduce the risk of fire. In addition, the formed carbon foam layer has good thermal insulation performance because of its loose structure, which can prevent high temperature from spreading to the surrounding and thereby serves as a good thermal insulation barrier.

Suitable intumescent thermal insulating material include, but are not limited to phosphorus containing materials, nitride containing materials, sulphur containing materials, boron-containing materials, compounds that release water vapor (e.g. calcium hydroxide, magnesium hydroxide, aluminum hydroxide, expandable graphite (EG)), pentaerythritol, kaolin or combinations thereof.

For example, the phosphorus containing materials include phosphorates, such as sodium phosphorate, potassium phosphorate or ammonium phosphorate, ammonium polyphosphorate (APP), monoammonium phosphorate, diammonium phosphorate, trichloroethyl phosphate (TCEP), trichloropropyl phosphate (TCPP), ammonium pyrophosphorate, triphenyl phosphate, etc. Nitrogen-containing materials include melamine, melamine salts, salts of phosphoric acid, guanidine, melamine cyanurate, melamine formaldehyde, methylolated melamine, hexamethoxymethyl melamine, urea, dimethylurea, melamine pyrophosphate, dicyandiamide, guanylurea phosphate and glycine. Sulphur containing materials include sulfonates, such as sodium sulfonate, potassium sulfonate or ammonium sulfonate, paratoluene sulfonate, sulphates, such as sodium sulphate, potassium sulphate or ammonium sulphate. Boron-containing materials include boric acid, and borate salts, such as ammonium pentaborate, zinc borate, sodium borate, lithium borate, aluminum borate, magnesium borate, and borosilicate. Compounds that release water vapor as they decompose upon heating exposure, include but are not limited to calcium hydroxide, magnesium dihydroxide, aluminum trihydroxide, or expandable graphite (EG). Other suitable intumescent thermal insulating materials include polyfunctional alcohol like pentaerythritol, kaolin and etc.

In an embodiment, the expandable graphite has an average particle size from 50 μm to 500 μm, preferably 50 μm to 300 μm, more preferably 100 μm to 200 μm. Present inventors found that when particle size is bigger than 500 μm, it is not easy to process. Meanwhile, when particle size is smaller than 50 μm, the expansion ratio is limited and thereby thermal insulating performance is also impaired.

In an embodiment, the binder is selected from polyurethane, epoxy resin, polyethylene, polypropylene, polystyrene or combinations thereof.

In a preferable embodiment, the binder is polyurethane. As described in section I (PU composite), the polyurethane is a reaction product of a reaction mixture including isocyanate and polyol reactive toward isocyanate. The isocyanate and polyol reactive toward isocyanate are the same as “isocyanate component” and “polyol reactive toward isocyanate” as described in section I (PU composite). For brevity, they are not repeated here.

In an embodiment, preferable polyols have weight average molecular weight from 1,000 to 10,000, preferably from 4,000 to 6,000. Preferably, the polyols have a functionality from 2 to 3. The inventors found that the laminated products produced by using above defined polyurethane materials are elastic and non-rigid.

In an embodiment, the laminated product has an expansion rate from 5 to 20. In other words, the laminated product can swell and expands to a product five times to twenty times thicker than the original product. Preferably, the laminated product has a thickness of less than 5 mm before expansion, and a maximum thickness of less than 25 mm after expansion. This property is particularly advantageous when the laminated product is used as a shell of battery system. It is expected that the expanded laminated product shall not be too thick since inside cavity space of the battery system is generally limited. Accordingly, with above preferred weight percentage and surface density of thermal insulating material, the laminated product after expansion has a thickness of no higher than 25 mm which will not destroy the battery components contained inside the battery system.

The expansion rate is defined by the value calculated from the thickness after expansion dividing by the thickness before expansion of the laminated product.

In an embodiment, the laminated product further includes at least one substrate layer placed in-between the thermal insulating layer and the polyurethane composite layer, the substrate layer includes fiber sheet, plastic sheet and metal sheet.

The fiber sheet is made from for example glass fibers (GF), carbon fibers, natural fibers (such as bamboo fibers), especially natural fibers in the form of woven fabrics or non-woven fabrics; the metal sheet is made from for example aluminum alloys, iron, steel or aluminum; and
the plastic sheet is made from for example polyethylene (PE), polyvinyl chloride (PVC), polyethylene terephthalate (PET), polybutylene terephthalate (PBT), polypropylene (PP), polyurethane (PU), polyamide (PA), polyvinyl butyral (PVB) or ethylene vinyl acetate (EVA).

In an embodiment, the laminated product further includes at least one metal sheet located on a side of the laminated product. When the laminated product is applied to the battery pack, the metal sheet is arranged on the side away from the battery cell. The metal sheet mainly further enhances mechanical strength of the laminated product.

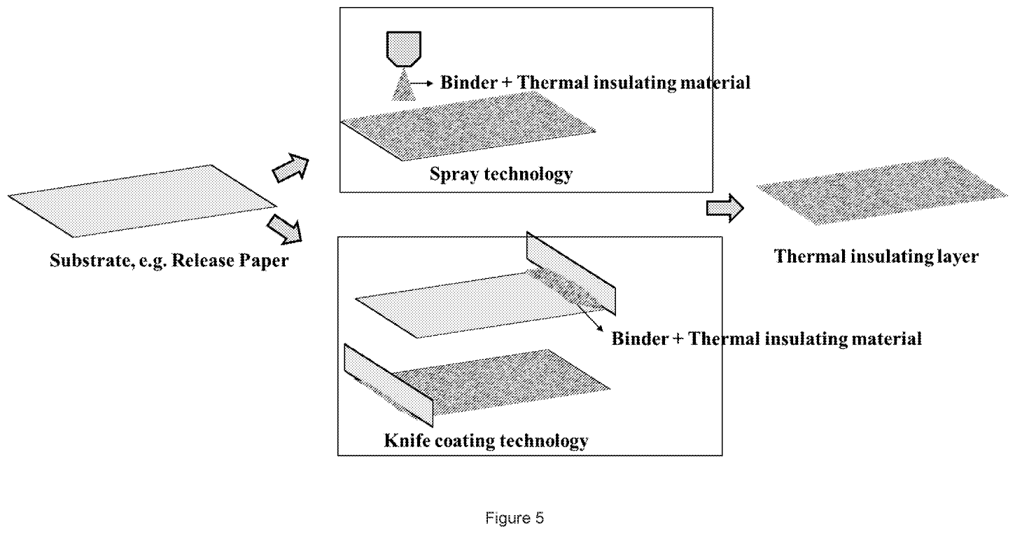

Process for preparing the thermal insulating layer is illustrated in FIG. 5. In specific, insome embodiments, the thermal insulating layer is prepared by
i) mixing a thermal insulating material with a binder;
ii) applying the mixture obtained in step i) onto a surface of substrate (e.g. by spraying or knife coating), and allowing the mixture to cure; and
iii) optionally removing the substrate to obtain the thermal insulating layer.

In a particular embodiment where the binder is polyurethane, the thermal insulating layer is prepared by:
i) mixing a thermal insulating material with a polyol component;
ii) mixing the mixture obtained in step i) with an isocyanate component;
iii) applying the mixture obtained in step ii) onto a surface of substrate (e.g. by spraying or knife coating), and allowing the mixture to cure; and
iv) optionally removing the substrate to obtain the thermal insulating layer.

It is noted that, the substrate used in above preparation method includes release paper, fiber sheet, plastic sheet and metal sheet. When the substrate is release paper, the release paper is removed from the final thermal insulating layer.

In an embodiment, the laminated product passes the UL94 V0 grade for fire test. In an embodiment, the laminated product passes UL 94 5VA fire test.

In an embodiment, the laminated product is tested against fire at 800-1300° C. (referred to as T1) on one side for 10 mins. Results show that temperature on the opposite side (referred to as T2) is below 400° C. In preferable embodiments, T2 is below 350° C. In more preferable embodiments, T2 is below 300° C. In even more preferable embodiments, T2 is below 280° C. And in most preferable embodiments, T2 is below 260° C.

### Process for Producing the Laminated Product

In a further aspect, the invention relates to a process for producing the laminated product as mentioned above, comprising the following steps:
1) providing a thermal insulating layer by
   i) mixing a thermal insulating material with a binder,
   ii) applying the mixture of step i) onto a surface of substrate (e.g. by spraying or knife coating), and allowing the mixture to cure; and
   iii) optionally removing the substrate;
2) providing a reinforced fiber in a continuous phase form, arranged on each side of the thermal insulating layer obtained in step 1);
3) preparing a polyol component by mixing the following materials in a tank under a temperature of 20 to 80° C.:
   (b) at least one polyol reactive toward isocyanate,
   (c) optionally a chain extender and/or a crosslinking agent,
   (d) a flame retardant,
   (e) optionally a filler,
   (f) a blowing agent,
   (g) a catalyst, and
   (h) optionally additives and/or auxiliaries;
4) mixing the polyol component obtained in step 3) with an isocyanate component and optionally a reinforced fiber in a discontinuous phase form under a temperature of 20 to 80° C. to give a mixture;
5) spraying or injecting the mixture obtained in step 4) onto the reinforced fiber in a continuous phase form arranged on each side of the thermal insulating layer provided in step 2) by a first nozzle or an injection head, and optionally spraying reinforced fibers in a discontinuous phase form onto the reinforced fiber in a continuous phase form provided in step 2) by a second nozzle, to obtain a sprayed or injected product;
6) hot-pressing the sprayed or injected product obtained in step 5) in a mold which has a temperature of 40 to 180° C. and under a hot press clamping force of 100 to 2000 ton; and
7) demolding and optionally trimming, thereby obtaining a laminated product comprising a polyurethane composite arranged on each side of the thermal insulating layer;
wherein the polyurethane composite comprises 35 to 75 wt % reinforced fiber and 25 to 65 wt % polyurethane foam, based on the total weight of the polyurethane composite;
the reinforced fiber comprises 75 to 100 wt % of the reinforced fiber in a continuous phase form and 0 to 25 wt % of the reinforced fiber in a discontinuous phase form, based on the total weight of the reinforced fiber; and
the reinforced fiber is selected from the group consisting of glass fiber, basalt fiber, carbon fiber and natural fiber, preferably glass fiber and basalt fiber, and more preferably glass fiber.

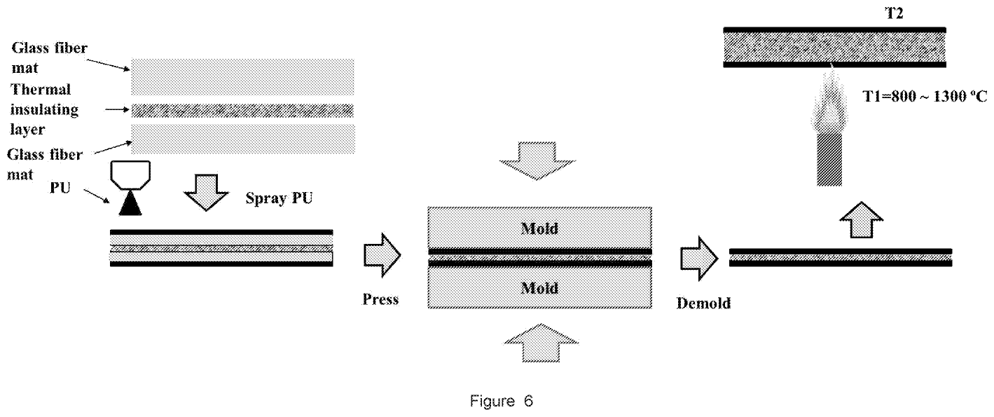

For easier understanding purpose, FIG. 6 illustrated an exemplary process for producing the laminated product.

In an embodiment, the reinforced fiber in a discontinuous phase form in step 4) is obtained by chopping long fibers on site, and is added into the mixture of the isocyanate component and the polyol component of polyurethane in a constant rate, and the chopped reinforced fiber has a length of 6 to 100 mm.

In an embodiment, the reinforced fiber in a continuous phase form in step 1) is in a form of mat, woven fabrics, or combinations thereof.

It is noted that suitable materials for preparing the thermal insulating layer are the same as those described in section II (Laminated Product). Suitable materials used in in above step 2)-5) are the same as those described in section I (PU Composite). For brevity, they are not repeated here.

### Spray Transfer Molding (STM) Process for Producing the Laminated Product

In an aspect, the invention relates to a spray transfer molding (STM) process for producing the laminated product as mentioned above, comprising the following steps:
1) providing a thermal insulating layer by
   i) mixing a thermal insulating material with a binder,
   ii) applying the mixture of step i) onto a surface of substrate (e.g. by spraying or knife coating), and allowing the mixture to cure; and
   iii) optionally removing the substrate;
2) providing a reinforced fiber in a continuous phase form, arranged on each side of the thermal insulating layer obtained in step 1);
3) preparing a polyol component by mixing the following materials in a tank under a temperature of 20 to 80° C.:
   (b) at least one polyol reactive toward isocyanate,
   (c) optionally a chain extender and/or a crosslinking agent,
   (d) a flame retardant,
   (e) optionally a filler,
   (f) a blowing agent,
   (g) a catalyst, and
   (h) optionally additives and/or auxiliaries;
4) mixing the polyol component obtained in step 3) with an isocyanate component under a temperature of 20 to 80° C. to give a mixture;
5) spraying the mixture obtained in step 4) onto the reinforced fiber in a continuous phase form arranged on each side of the thermal insulating layer provided in step 2) by a first nozzle, and optionally spraying reinforced fibers in a discontinuous phase form onto the reinforced fiber in a continuous phase form provided in step 2) by a second nozzle, to obtain a sprayed product;
6) hot-pressing the sprayed product obtained in step 5) in a mold which has a temperature of 40 to 180° C. and under a hot press clamping force of 100 to 2000 ton; and
7) demolding and optionally trimming, thereby obtaining a laminated product comprising a polyurethane composite arranged on each side of the thermal insulating layer;
wherein the polyurethane composite comprises 35 to 75 wt % reinforced fiber and 25 to 65 wt % polyurethane foam, based on the total weight of the polyurethane composite;
the reinforced fiber comprises 75 to 100 wt % of the reinforced fiber in a continuous phase form and 0 to 25 wt % of the reinforced fiber in a discontinuous phase form, based on the total weight of the reinforced fiber; and
the reinforced fiber is selected from the group consisting of glass fiber, basalt fiber, carbon fiber and natural fiber, preferably glass fiber and basalt fiber, and more preferably glass fiber.

It is noted that, all the elements (such as but not limited to, the raw materials used, conditions (temperature, pressure, etc.), equipment or devices, orders of the steps) used in “Spray transfer molding (STM) process for producing the PU composite” also apply to step 2)-7) of the STM process for producing the laminated product, unless otherwise stated. For brevity, they are not repeated here.

### Long Fiber Injection (LFI) Process for Producing the Laminated Product

In another aspect, the invention relates to a long fiber injection (LFI) process for producing the laminated product as mentioned above, comprising the following steps:
1) providing a thermal insulating layer by
   i) mixing a thermal insulating material with a binder,
   ii) applying the mixture of step i) onto a surface of substrate (e.g. by spraying or knife coating), and allowing the mixture to cure; and
   iii) optionally removing the substrate;
2) providing a reinforced fiber in a continuous phase form, arranged on each side of the thermal insulating layer obtained in step 1);
3) preparing a polyol component by mixing the following materials in a tank under a temperature of 20 to 80° C.:
   (b) at least one polyol reactive toward isocyanate,
   (c) optionally a chain extender and/or a crosslinking agent,
   (d) a flame retardant,
   (e) optionally a filler,
   (f) a blowing agent,
   (g) a catalyst, and
   (h) optionally additives and/or auxiliaries;
4) mixing the polyol component obtained in step 3) with an isocyanate component and a reinforced fiber in a discontinuous phase form under a temperature of 20 to 80° C. to give a mixture;
5) injecting the mixture obtained in step 4) onto the reinforced fiber in a continuous phase form arranged on each side of the thermal insulating layer provided in step 2) by an injection head, to obtain an injected product;
6) hot-pressing the injected product obtained in step 5) in a mold which has a temperature of 40 to 180° C. and under a hot press clamping force of 100 to 2000 ton; and
7) demolding and optionally trimming, thereby obtaining a laminated product comprising a polyurethane composite arranged on each side of the thermal insulating layer;
wherein the polyurethane composite comprises 35 to 75 wt % reinforced fiber and 25 to 65 wt % polyurethane foam, based on the total weight of the polyurethane composite;
the reinforced fiber comprises 75 to 100 wt % of the reinforced fiber in a continuous phase form and 0 to 25 wt % of the reinforced fiber in a discontinuous phase form, based on the total weight of the reinforced fiber; and the reinforced fiber is selected from the group consisting of glass fiber, basalt fiber, carbon fiber and natural fiber, preferably glass fiber and basalt fiber, and more preferably glass fiber.

It is noted that, all the elements (such as but not limited to, the raw materials used, conditions (temperature, pressure, etc.), equipment or devices, orders of the steps) used in “Long fiber injection (LFI) process for producing the PU composite” also apply to step 2)-7) of the LFI process for producing the laminated product, unless otherwise stated. For brevity, they are not repeated here.

It has been surprisingly found in this application that, the laminated product as mentioned above or the laminated product prepared by the process as mentioned above shows light weight, good mechanical strength, flame resistance and good thermal insulation property at same time. Moreover, the process is carried out in a robust and easy way. Correspondingly, the laminated product is obtained cost-effectively.

In a still further aspect, the invention relates to a covering article suitable for battery system, comprising the laminated product as mentioned above or the laminated product prepared by the process as mentioned above.

It is noted that, through the whole application, the materials mentioned in the process embodiments have the same meanings as those in the product embodiments, and each of the general, preferable, more preferable and most preferable definitions and the amounts of the materials as described in the product part also applies to the processes for preparing the product and the articles made of the product, unless otherwise stated.

### EXAMPLE

The present invention will now be described with reference to Examples and Comparative Examples, which are not intended to limit the present invention.

### General Description

The following starting materials are used in the examples:

| | Components | Supplier | Description |
|---|---|---|---|
| Polyol 1 | Lupranol ® 2095 | BASF | OHv: 26~35 Mw: |
| | | | 3000~6000 |
| Polyol 2 | Lupranol ® 3300 | BASF | OHv: 400~600; Mw: |
| | | | 300~500 |
| Polyol 3 | Lupranol ® 3505/1 | BASF | OHv: 600~1200; Mw: |
| | | | 180~300 |
| Polyol 4 | LUPRAPHEN 3905 | BASF | OHv 175~310; Mw: |
| | | | 350~650; Aromatic |
| | | | polyester |
| Polyol 5 | Lupranol ® VP 9343 | BASF | Mw: 5000~6000 |
| Chain | MonoEthylene Glycol | | Cas No.: 107-21-1 |
| extender | (MEG) | | |
| Crosslinker | Glycerin | Ourchem | |
| Flame | Expandable graphite | LUH | |
| retardant | (EG) | | |
| | tris(1-chloro-2-propyl) | Albright and | CAS No: 13674-84-5 |
| | phosphate (TCPP) | Wilson Ltd. | |
| | IXOL B251 | Solvay | |
| Intumescent | Expandable graphite | LUH | |
| component | (EG) | | |
| | APP 422 | Clariant | Exolit AP 422 |
| | Melamine | Sichuan | |
| | | Golden-Elephant | |
| | | Sincerity Chemical | |
| | | Co., LTd. | |
| | Pentaerythite | Hangzhou JLS | JLS PENTA(95%) |
| | | Flame Retardants | |
| | | Chemical Co., Ltd. | |
| | Kaolin | Xinzhou Bright | DB-80 Kaolin |
| | | Industry Ltd. | |
| Filler | titanium oxide | | CAS No: 13463-67-7 |
| Blowing | water | | |
| agent | | | |
| Catalyst | JEFFCAT ZF 50, | Huntsman | |
| | Polycat 8 | Evonik | |
| | UL 32 | Momentive | |
| Surfactant | DABCO DC 193 | Evonik | |
| Isocyanate | Lupranat M 20 S | BASF | |
| | Lupranat MM 103C | BASF | |
| | Lupranat MP 102 | BASF | a liquid, modified short |
| | | | chain prepolymer based |
| | | | on pure 4,4′-MDI. |
| Reinforced | E512 | Jushi | continues fiber |
| fibers | E440 | Jushi | Non-continues fiber |

The following methods were used to determine properties:

| | |
|---|---|
| Density in kg/m³ | GB/T 6343-2008 |
| Flammability | UL94 V0 |
| | UL 94 5VA standard |
| Tensile strength/modulus | GB/T1447-2005 |
| Flexural strength/modulus | GB/T1449-2005 |

### Example A: PU Composite

### I. Preparation Examples

PU composites of Examples 1 to 5 and Comparative Example 1 were prepared using the polyol component, the isocyanate component and the reinforced fiber in an amount as defined in table 1. The PU composite of Comparative Example 2 was purchased commercially under the name of HY3102SMC from HUAYUAN ADV. MATERIALS, which was prepared by a prior sheet molding compound (SMC) process.

TABLE 1

| | | | | | | | Com. |
|---|---|---|---|---|---|---|---|
| | | | | | | Com. | Ex.2 |
| | Ex. 1 | Ex. 2 | Ex. 3 | Ex. 4 | Ex. 5 | Ex. 1 | (SMC) |
| component | | | | | | | |
| Polyol | 35.69 | 31.75 | 18.18 | 14.71 | 10.53 | 38.46 | |
| component A | | | | | | | |
| Polyol 1 | 4.25 | 4.24 | 0.73 | 0 | 0 | 4.6 | |
| Polyol 2 | 5.36 | 6.35 | 1.82 | 0 | 0 | 7.69 | |
| Polyol 3 | 7.14 | 3.81 | 4.16 | 7.35 | 5.68 | 9.62 | |
| Polyol 4 | 0 | 0 | 1.82 | 0 | 0 | 0 | |
| Chain | 2.14 | 0.95 | 0.73 | 0.44 | 0.32 | 2.31 | |
| extender MEG | | | | | | | |
| Crosslinker | 0 | 1.59 | 0.73 | 0.88 | 0.63 | 0 | |
| Glycerin | | | | | | | |
| Flame retardant, | 8.93 | 7.94 | 2.73 | 2.94 | 2.95 | 9.62 | |
| TCPP | | | | | | | |
| Flame retardant, | 3.57 | 3.17 | 2.55 | 1.47 | 0.84 | 3.85 | |
| IXOL B251 | | | | | | | |
| expandable | 3.57 | 3.17 | 2.73 | 1.47 | 0 | 0 | |
| graphite | | | | | | | |
| Fillers* | 0 | 0 | 0 | 0 | 0 | 0 | 30 |
| titanium oxide | | | | | | | |
| Blowing agent, | 0.3 | 0.27 | 0.11 | 0.07 | 0.05 | 0.33 | |
| water | | | | | | | |
| Catalyst, | 0.11 | 0.06 | 0.04 | 0.03 | 0.02 | 0.12 | |
| JEFFCAT ZF 50 | | | | | | | |
| Catalyst, | 0.11 | 0.03 | 0 | 0.01 | 0.01 | 0.12 | |
| Polycat 8 | | | | | | | |
| DABCO DC 193 | 0.21 | 0.16 | 0.05 | 0.04 | 0.03 | 0.2 | |
| isocyanate | 28.57 | 28.57 | 27.27 | 26.47 | 15.79 | 30.77 | |
| component B | | | | | | | |
| Lupranat M 20S | 21.43 | 26.98 | 26.36 | 23.53 | 13.68 | 23.07 | |
| Lupranat MM 103C | 3.57 | 1.59 | 0 | 2.94 | 2.11 | 3.85 | |
| Lupranat MP 102 | 3.57 | 0 | 0.91 | 0 | 0 | 3.85 | |
| Reinforced fibers: | 35.71 | 39.68 | 54.55 | 58.82 | 73.68 | 30.77 | 30 |
| glass fiber | | | | | | | |
| Continuous | 26.07 | 36.51 | 45.45 | 58.82 | 73.68 | 23.08 | 0 |
| reinforced fibers: | | | | | | | |
| glass fiber mat | | | | | | | |
| Discontinuous | 9.64 | 3.17 | 9.09 | 0 | 0 | 7.69 | 30 |
| reinforced fibers: | | | | | | | |
| long glass fiber, | | | | | | | |

*as mentioned in the previous text, the fillers contained in the polyol component does not include the reinforced fiber.

### Examples 1˜3

PU composites according to the present invention were produced by long fiber injection (LFI) process, comprising the following steps.

The materials under polyol component A as described in of table 1 were mixed to form the polyol component A. The materials under isocyanate component B as described in table 1 were mixed to form the isocyanate component B. The resulting polyol component A and isocyanate component B were statically mixed at pressure of 4 bar to obtain a mixture with a viscosity of about 200 mPa·s, and the reinforced fiber was chopped and added into the resulting mixture under stirring to give a final mixture, wherein the chopped reinforced fiber had a length of 15 mm. The final mixture was injected at an amount of about 650 g/m² into an open mold which had been preheated at around 110° C. and was designed to have knifes for cutting trimmings and digging screw holes and to allow to fix inserts (for example, glass fiber mats and/or such as metal sheet, metal foil or solid flame retardant layer), in which 2 layers of glass fiber mats was placed. The mold was subsequently closed and clamped at about 800 ton.

The part was molded for 5 min and then demolded. A product with a thickness of about 1.8 mm was obtained.

From table 1, it can be seen that the amount of the continuous and discontinuous reinforced fibers as used to the amount of polyol component A and isocyanate component B as used as the starting materials was in a ratio of (35˜55):(45˜65).

### Examples 4 and 5

PU composites according to the present invention were produced by spray transfer molding (STM) process, comprising the following steps.

The materials under polyol component A as described in table 1 were mixed and maintained at a tank temperature of from 30° C. to 40° C. to prepare the polyol component A with a reduced viscosity. The materials under isocyanate component B as described in table 1 were mixed to form the isocyanate component B. The polyol component A and the isocyanate component B were impingement mixed at a pressure around 150 bar to obtain a mixture with a viscosity of about 500 mPa·s. Then, the mixture was sprayed at an amount of about 650 g/m² onto the surface of glass fiber mat of 2 layers.

At about atmospheric pressure, the resulting PU with glass fiber was placed by a robot onto an open mold which had been preheated at around 110° C. and was designed to have knifes for cutting trimmings and digging screw holes and to allow to fix inserts (for example, glass fiber mats and/or such as metal sheet, metal foil or solid flame retardant layer), and the mold was subsequently closed and clamped at about 500 ton.

The part was molded for 5 min and then demolded. A product with a thickness of about 1.8 mm˜2.4 mm was obtained.

### Comparative Example 1

A PU composite was prepared by the same process as described in Examples 1˜3. A product with the thickness of about 1.4 mm was obtained.

### II. Effect of the Examples

### Test of the Properties of the PU Composite Products

The physical and chemical properties for the PU composite products of the preparation examples are listed in Table 2.

TABLE 2

| | | | | | | | Com |
|---|---|---|---|---|---|---|---|
| | | | | | | Com. | Ex. 2 |
| Sample | Ex. 1 | Ex. 2 | Ex. 3 | Ex. 4 | Ex. 5 | Ex. 1 | (SMC) |
| Filler content (%) | 0 | 0 | 0 | 0 | 0 | 0 | 30 |
| Thickness (mm) | 1.8 | 1.9 | 1.8 | 1.8 | 2.4 | 1.4 | 2.5 |
| Density (g/cm3) | 1.16 | 1.25 | 1.33 | 1.27 | 1.4 | 1.17 | 1.8 |
| Tensile strength | 95.2 | 118 | 162 | 133 | 143 | 69 | 65 |
| (MPa) | | | | | | | |
| Tensile Modulus | 6293 | 7500 | 7100 | 8100 | 10140 | 5000 | 8000 |
| (MPa) | | | | | | | |
| Flexural strength | 173 | 185 | 272 | 290 | 219 | 150 | 175 |
| (MPa) | | | | | | | |
| Flexural modulus | 6610 | 7450 | 9300 | 9690 | 9270 | 5500 | 8000 |
| (MPa) | | | | | | | |
| FR UL 94 VO | Pass | Pass | Pass | Pass | Pass | Fail | Pass |
| FR UL 94 5VA | Pass | Pass | Pass | Pass | Pass | Fail | — |

### Example 6˜7-Test of the Electromagnetic Shielding Property of the Covering Article

Covering articles of Ex. 6 and Ex. 7 comprising the PU composites of Ex. 2 and Ex. 4, respectively, were prepared. The covering articles contained a sheet of PU composite as a core layer, and one aluminum alloy sheet with a thickness of 0.2 mm, located on one side of the core layer.

The electromagnetic shielding performances of these covering articles were tested. The results were listed in Table 3.

TABLE 3

| Sample | Ex. 6 | Ex. 7 |
|---|---|---|
| E0/E1 | 1000:1 | 10,000:1 |
| SE [dB] | 60 | 80 |

### Example 8˜10-Test of Fire Performance of the Battery Pack

Battery packs of Ex. 8 to Ex. 10 comprising the covering articles of Ex. 3 to Ex. 5, respectively, were prepared. The battery packs each comprised a covering article and a bottom tray. The bottom tray was made of a stamped aluminum alloy sheet.

The fire performances of these battery packs were tested. The results were listed in Table 4.

External fire burning test: GB 38031-2020
Test method: (8.2.7.1)
   Ignite the fuel Pan from distance≥3m from the target.
   Pre-heat the fire for 60s
   Move the fuel pan under the battery pack.
   Directly expose the battery pack to fire for 70s.
   Add a cover on the fuel pan, and continue the test for 60s
   Remove the fuel pan
   Observe the battery pack for 2 hrs.
Requirement: (5.2.7).
   The battery pack should not explode
   Nickle hydrogen battery not applied

TABLE 4

| Sample | Ex. 8 | Ex. 9 | Ex. 10 |
|---|---|---|---|
| fire burning test | pass | pass | pass |

As can be seen from Table 3, the covering articles containing the PU composites according to the invention have good EMI shielding performance.

As can be seen from Table 4, the battery packs containing the covering articles according to the invention as upper cover pass the external fire burning test.

### Ex. 11-13 Test of Voltage Resistance

Covering article of Example 11 comprises two layers of PU composite of Ex.4 which are hot pressed together. Covering article of Example 12 comprises one PU composite of Ex.4 and one steel sheet (thickness=0.2 mm) placed on one side of the PU composite. Covering article of Example 13 comprises one steel sheet (thickness=0.2 mm) and two layers of PU composite of Ex.4 placed on two sides of the aluminum alloy sheet.

To evaluate their voltage resistance performance, the covering articles of Example 11-13 were tested against high DC voltage (3000V) for 60 seconds. Then, the covering articles were burned against fire at 1000° C. for 30 minutes. For covering article of Example 12, the PU composite side was burned against fire. And the burned covering articles of Example 11-13 were tested against high DC voltage (3000V or 1000V) for 60 seconds again.

Test results are shown in below table 5. It is noted that covering articles of Example 11-13 before burning show a leakage current being below 3 mA under voltage of 3000V. Covering article of Example 12 after burning shows a leakage current being below 3 mA under voltage of 1000V while covering articles of Examples 11 and 13 further show a leakage current being below 3 mA even under voltage of 3000V. Besides, none of the covering articles of Example 11-13 shows electric breakdown or flashover.

These test results show that covering articles of Example 11-13 have excellent voltage resistance and electric insulating property which makes them particularly suitable as cover/shell for battery system.

TABLE 5

| | | Electric | | |
|---|---|---|---|---|
| | Voltage | breakdown? | Flashover? | Leakage |
| | applied | Yes (Y)/ | Yes (Y)/ | current <3 |
| Examples | [V] | No (N) | No (N) | mA |
| Ex. 11 (Before | 3000 | N | N | Y |
| burning) | | | | |
| Ex. 11 (After | 3000 | N | N | Y |
| burning) | | | | |
| Ex. 12 (Before | 3000 | N | N | Y |
| burning) | | | | |
| Ex. 12 (After | 1000 | N | N | Y |
| burning) | | | | |
| Ex. 13 (Before | 3000 | N | N | Y |
| burning) | | | | |
| Ex. 13 (After | 3000 | N | N | Y |
| burning) | | | | |

### Example B: Laminated Product

### I. Preparation Examples

### Examples 14 to 17: Preparation of Intumescent Thermal Insulating Layer

Intumescent thermal insulating layers of Examples 14 and 15 were prepared using the polyol component, the isocyanate component and the intumescent component in an amount as defined in table 6.

TABLE 6

| | Example 14 | Example 15 |
|---|---|---|
| component | 100.0 | 100.0 |
| polyol component A′ | 48.78 | 49.50 |
| Lupranol ® 2095 | 27.80 | 20.54 |
| Lupranol VP 9343 | 7.32 | 14.85 |
| Chain extender MEG | 3.17 | 3.37 |
| Cross linker Glycerin | 0.49 | 0.50 |
| Flame retardant, TCPP | 9.76 | 9.90 |
| Blowing agent, water | 0.15 | 0.25 |
| Catalyst, JEFFCAT ZF 50 | 0.05 | 0.05 |
| Catalyst, UL 32 | 0.005 | 0.005 |
| silicone surfactant, DABCO DC 193 | 0.05 | 0.05 |
| isocyanate component B′ | 21.95 | 23.77 |
| Lupranat M 20 S | 9.76 | 12.38 |
| Lupranat MM 103C | 8.78 | 7.43 |
| Lupranat MP 102 | 3.41 | 3.96 |
| intumescent component | 29.27 | 26.73 |
| Expandable graphite, with an average | 29.27 | 0.00 |
| particle size of 150~200 μm | | |
| APP 422 (ammonium polyphosphate) | | 7.92 |
| Melamine | | 8.42 |
| Pentaerythritol | | 7.43 |
| Kaolin | | 2.96 |

### Example 14

Intumescent thermal insulating layer according to the present invention was produced by spraying technology, comprising the following steps.

The materials under polyol component A′ as described in table 6 were mixed to form the polyol component A′. The materials under isocyanate component B′ as described in table 6 were mixed to form the isocyanate component B′. Expandable graphite was premixed into polyol component A′ and maintained at a tank with temperature from 30° C. to 40° C. to obtain a premixed mixture. The premixed mixture and an isocyanate component B′ were mixed at a pressure of around 10 bar to obtain a mixture. Then, the mixture were sprayed onto a release paper in an amount to obtain an intumescent thermal insulating layer having surface density being about 100 g/m², which was also referred to as layer of “IL100”.

Then, the release paper with intumescent thermal insulating material was heated and cured in an oven of about 100° C. for 5 mins, and subsequently the intumescent thermal insulating layer was removed from release paper.

### Example 15

Intumescent thermal insulating layer according to the present invention was produced by knife coating technology.

The materials under polyol component A′ as described in table 6 were mixed to form the polyol component A′. The materials under isocyanate component B′ as described in table 6 were mixed to form the isocyanate component B′. Intumescent components including APP 422, melamine, pentaerythritol, and kaolin were premixed into polyol component A′ and maintained at a tank with temperature from 30° C. to 40° C. to obtain a premixed mixture. The premixed mixture and an isocyanate component B′ were impingement mixed at a pressure of around 150 bar to obtain a mixture. Then, the mixture were knife coated onto a release paper in an amount to obtain an intumescent thermal insulating layer having surface density being about 100 g/m², which was also referred to as layer of “IL 100-2”.

Then, the release paper with intumescent thermal insulating material was heated and cured in an oven of about 100° C. for 5 min, and subsequently the intumescent thermal insulating layer was removed from release paper.

Intumescent thermal insulating layers of Examples 16 and 17 were prepared by the same process as described in Example 14, except that the sprayed amount and knife coated amount were altered to obtain intumescent thermal insulating layers having surface density of about 150 g/m² and 230 g/m² respectively, which were also referred to as “IL150” or “IL230”.

### Examples 18 to 23: Preparation of Laminated Product

A laminated product of Example 18 was produced by spray transfer molding (STM) process, comprising the following steps.

As shown in FIG. 6, the intumescent thermal insulating layer of Ex. 14 (i.e. IL100) was provided and 2 layers of glass fiber mats were placed on both sides of the intumescent thermal insulating layer.

The materials under polyol component A as described in Ex. 4 of Table 1 were mixed and maintained at a tank with temperature from 30° C. to 40° C. to prepare the polyol component A with a reduced viscosity. The materials under isocyanate component B as described in Ex. 4 of Table 1 were mixed to form the isocyanate component B. The polyol component A and the isocyanate component B were impingement mixed at a pressure of around 150 bar to obtain a mixture with a viscosity of about 500 mPa·s. Then, the mixture was sprayed at an amount of about 650 g/m² onto glass fiber mat (having surface density=750 g/m²) placed on one side of the intumescent thermal insulating layer. The mixture was sprayed at an amount of about 650 g/m² onto glass fiber mat (having surface density=200 g/m² respectively) placed on the other side of the intumescent thermal insulating layer.

At about atmospheric pressure, the resulting product comprising intumescent thermal insulating layer and two polyurethane composites arranged on each side of the intumescent thermal insulating layer were placed by a robot onto an open mold which had been preheated at around 110° C. and was designed to have knifes for cutting trimmings and digging screw holes and to allow to fix inserts (for example, metal sheet or metal foil), and the mold was subsequently closed and clamped at about 500 ton.

The part was molded for 5 min and then demolded and a laminated product was obtained, which was also referred to as GF750/IL100/GF200.

The laminated products of Examples 19 and 20 were prepared by the same process as described in Example 18, except that Example 19 used the intumescent thermal insulating layers of Example 16 (i.e. “IL150”) while Example 20 used the intumescent thermal insulating layers of Example 17 (i.e. “IL230”). The laminated products of Examples 21 and 22 were prepared by the same process as described in Example 18, except that surface density of the glass fiber mats were altered as shown in Table 7.

A laminated product of Example 23 was produced by same process as example 18, except that the intumescent thermal insulating layer is made according to Ex. 15 (i.e. IL100-2).

### Comparative Example 3

A product of Com Ex. 3 was prepared by the same process as described in Example 18, except that the intumescent thermal insulating layer is not provided. The product is referred to as GF750/GF200.

### II. Effect of the Examples

The laminated products prepared according to Ex. 18-23 and Com Ex.3 are tested against fire at 1300° C. (T1) on one side for 10 mins. Temperature on the opposite side is recorded as T2 as shown in table 7.

TABLE 7

| | PU composite | | | |
|---|---|---|---|---|
| | layer/intumescent | Thickness of the | | |
| | thermal insulating | laminate product | | Temperature |
| Examples | layer/PU composite layer | after Expansion | | T2 |
| Com Ex. 3 | GF750/GF200 | | | Burnt |
| | | | | through |
| Ex. 18 | GF750/IL100/GF200 | 7~8 | mm | <320° C. |
| Ex. 19 | GF750/IL150/GF200 | 12~13 | mm | <280° C. |
| Ex. 20 | GF750/IL230/GF200 | 16~17 | mm | <260° C. |
| Ex. 21 | GF750/IL100/GF450 | 7~8 | mm | <260° C. |
| Ex. 22 | GF750/IL100/GF750 | 7~8 | mm | <185° C. |
| Ex. 23 | GF750/IL100-2/GF200 | 4~6 | mm | <400° C. |

As shown in above table 7, laminated products prepared according to present application (Ex. 18-23) show excellent thermal insulating performance as the temperature in the opposite side T2 is below 400° C. Particularly, T2 of Ex. 18-22 are even lower than 320° C.

To evaluate voltage resistance performance of the laminated product, the laminated product of Example 22 was tested against high DC voltage (3000V) for 60 seconds. Then, the laminated product was burned against fire at 1000° C. for 30 minutes. And the burned covering article of Example 22 was tested against high DC voltage (3000V) for 60 seconds again.

Test results are shown in below table 8. It is noted that the laminated product of Example 22 shows a leakage current being below 3 mA under voltage of 3000V before and after burning. Besides, it does not occur electric breakdown or flashover.

These test results show that laminated product of Example 22 has excellent voltage resistance and electric insulating property which makes it particularly suitable as cover/shell for battery system.

TABLE 8

| | | Electric | | |
|---|---|---|---|---|
| | Voltage | breakdown? | Flashover? | Leakage |
| | applied | Yes (Y)/ | Yes (Y)/ | current <3 |
| Examples | [V] | No (N) | No (N) | mA |
| Ex. 22 (Before | 3000 | N | N | Y |
| burning) | | | | |
| Ex. 22 (After | 3000 | N | N | Y |
| burning) | | | | |

The structures, materials, components, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1. A polyurethane composite, wherein the polyurethane composite comprises 35 to 75 wt % reinforced fiber and 25 to 65 wt % polyurethane foam, based on the total weight of the polyurethane composite,
wherein the polyurethane foam is obtained from a two-component reactive system comprising an isocyanate component consisting of
(a) at least one isocyanate or isocyanate prepolymer, and
a polyol component consisting of
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries,
wherein the reinforced fiber is selected from the group consisting of glass fiber, basalt fiber, carbon fiber and natural fiber, and
the reinforced fiber comprises 75 to 100 wt % of the reinforced fiber in a continuous phase form and 0 to 25 wt % of the reinforced fiber in a discontinuous phase form, based on the total weight of reinforced fiber.

2. The polyurethane composite according to claim 1, wherein the reinforced fiber is impregnated with polyurethane foam.

3. The polyurethane composite according to claim 1, wherein the reinforced fiber in a continuous phase form is in a form of mat, woven fabrics, or combinations thereof.

4. The polyurethane composite according to claim 3, wherein the polyurethane composite comprises 1 layer to 4 layers of the mat, woven fabrics, or combinations thereof.

5. The polyurethane composite according to claim 1, wherein the reinforced fiber in a discontinuous phase form has a length of 6 to 100 mm.

6. The polyurethane composite according to claim 1, wherein the polyurethane composite has a density of less than 2.2 g/cm³.

7. The polyurethane composite according to claim 1, wherein the polyurethane composite is made in a form of sheet having a thickness of 0.5 to 10 mm.

8. The polyurethane composite according to claim 1, wherein the polyurethane composite comprises flame retardant (d) selected from the group consisting of expandable graphite, red phosphorus, ammonium polyphosphate, triethyl phosphate, tris(2-clorisopropyl)phosphate. melamine, expandable graphite (EG), red phosphorus, ammonium polyphosphate, tris(1-chloro-2-propyl)phosphate (TCPP), triethyl phosphate (TEP), chlorine and bromine containing polyols, epichlorohydrin, chlorendic anhydride, trichlorobutylene oxide (TCBO), phosephorus containing polyols esters of ortho-phosphoric acid, esters of phosphorus acid, phosphanate polyols, phosphine oxide polyols, and phosphoramidic polyols.

9. The polyurethane composite according to claim 1, wherein the polyurethane composite passes the UL94 V0 grade for fire test.

10. A process for producing the polyurethane composite according to claim 1, wherein the process comprises the following steps:
1) providing a reinforced fiber in a continuous phase form;
2) preparing a polyol component by mixing the following materials in a tank under a temperature of 20 to 80° C.:
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries;
3) mixing the polyol component obtained in step 2) with an isocyanate component and optionally a reinforced fiber in a discontinuous phase form under a temperature of 20 to 80° C. to give a mixture;
4) spraying or injecting the mixture obtained in step 3) onto the reinforced fiber in a continuous phase form provided in step 1) by a first nozzle or an injection head, and optionally spraying reinforced fibers in a discontinuous phase form onto the reinforced fiber in a continuous phase form provided in step 1) by a second nozzle to obtain a sprayed or injected product;
5) hot-pressing the sprayed or injected product obtained in step 4) in a mold which has a temperature of 40 to 180° C. and under a hot press clamping force of 100 to 2000 ton; and
6) demolding and optionally trimming;
wherein the polyurethane composite obtained in step 6) comprises 35 to 75 wt % reinforced fiber and 25 to 65 wt % polyurethane foam, based on the total weight of the polyurethane composite;
wherein the reinforced fiber comprises 75 to 100 wt % of the reinforced fiber in a continuous phase form and 0 to 25 wt % of the reinforced fiber in a discontinuous phase form, based on the total weight of the reinforced fiber; and
wherein the reinforced fiber is selected from the group consisting of glass fiber, basalt fiber, carbon fiber, and natural fiber.

11. The process according to claim 10, wherein the reinforced fiber in a discontinuous phase form in step 3) is obtained by chopping long fibers on site, and is added into the mixture of the isocyanate component and the polyol component of polyurethane in a constant rate, and the chopped reinforced fiber has a length of 6 to 100 mm.

12. The process according to claim 10, wherein the reinforced fiber in a continuous phase form in step 1) is in a form of mat, woven fabrics, or combinations thereof.

13. A covering article, comprising the polyurethane composite according to claim 1.

14. The covering article according to claim 13, further comprising at least one metal sheet located on at least one side of the PU composite.

15. The covering article according to claim 14, comprising two metal sheets located on each side of the PU composite.

16. The covering article according to claim 13, wherein the metal sheet is selected from the group consisting of aluminum alloy, iron, steel and aluminum sheet.

17. The covering article according to claim 13, wherein the metal sheet has a thickness of between 0.08 and 1.2 mm.

18. The covering article according to claim 13, wherein the metal sheet has a thickness of between 0.2 and 1.2 mm.

19. A laminated product, wherein the laminated product comprises
at least one thermal insulating layer; and
at least two layers of polyurethane composite according to claim 1 arranged on each side of the thermal insulating layer;
wherein the thermal insulating layer comprises a binder and a thermal insulating material distributed in the binder.

20. The laminated product according to claim 19, wherein the thermal insulating layer comprises 10 wt % to 70 wt % of the thermal insulating material, based on the total weight of the thermal insulating layer.

21. The laminated product according to claim 19, wherein the thermal insulating layer has a surface density from 50 g/m² to 500 g/m².

22. The laminated product according to claim 19, wherein the thermal insulating layer is intumescent thermal insulating layer, and the thermal insulating material is intumescent thermal insulating material, which is selected from the group consisting of phosphorus containing materials, nitride containing materials, sulphur containing materials, boron-containing materials, calcium hydroxide, magnesium hydroxide, aluminum hydroxide, expandable graphite (EG), pentaerythritol, kaolin, and combinations thereof.

23. The laminated product according to claim 22, wherein the expandable graphite has an average particle size from 50 μm to 500 μm.

24. The laminated product according to claim 19, wherein the binder is selected from the group consisting of polyurethane, epoxy resin, polyethylene, polypropylene, polystyrene, and combinations thereof.

25. The laminated product according to claim 24, wherein the binder is polyurethane, the polyurethane is a reaction product of a reaction mixture comprising isocyanate and polyol reactive toward isocyanate, wherein the polyol reactive toward isocyanate comprises polyols having weight average molecular weight from 1,000 to 10,000.

26. The laminated product according to claim 25, wherein the polyol reactive toward isocyanate has a functionality from 2 to 3.

27. The laminated product according to claim 19, wherein the laminated product has an expansion rate from 5 to 20.

28. The laminated product according to claim 19, wherein the laminated product further comprises at least one substrate layer placed in-between the thermal insulating layer and the layer of polyurethane composite, the substrate layer comprises fiber sheet, plastic sheet and metal sheet.

29. The laminated product according to claim 28, wherein the laminated product further comprises at least metal sheet located on a side of the laminated product.

30. A process for producing the laminated product according to claim 19, comprising the following steps:
1) providing a thermal insulating layer by
i) mixing a thermal insulating material with a binder,
ii) applying the mixture of step i) onto a surface of substrate, and allowing the mixture to cure; and
iii) optionally removing the substrate;
2) providing a reinforced fiber in a continuous phase form, arranged on each side of the thermal insulating layer obtained in step 1);
3) preparing a polyol component by mixing the following materials in a tank under a temperature of 20 to 80° C.:
(b) at least one polyol reactive toward isocyanate,
(c) optionally a chain extender and/or a crosslinking agent,
(d) a flame retardant,
(e) optionally a filler,
(f) a blowing agent,
(g) a catalyst, and
(h) optionally additives and/or auxiliaries;
4) mixing the polyol component obtained in step 3) with an isocyanate component and optionally a reinforced fiber in a discontinuous phase form under a temperature of 20 to 80° C. to give a mixture;
5) spraying or injecting the mixture obtained in step 4) onto the reinforced fiber in a continuous phase form arranged on each side of the thermal insulating layer provided in step 2) by a first nozzle or an injection head, and optionally spraying reinforced fibers in a discontinuous phase form onto the reinforced fiber in a continuous phase form provided in step 2) by a second nozzle, to obtain a sprayed or injected product;
6) hot-pressing the sprayed or injected product obtained in step 5) in a mold which has a temperature of 40 to 180° C. and under a hot press clamping force of 100 to 2000 ton; and
7) demolding and optionally trimming, thereby obtaining a laminated product comprising a polyurethane composite arranged on each side of the thermal insulating layer;
wherein the polyurethane composite comprises 35 to 75 wt % reinforced fiber and 25 to 65 wt % polyurethane foam, based on the total weight of the polyurethane composite;
wherein the reinforced fiber comprises 75 to 100 wt % of the reinforced fiber in a continuous phase form and 0 to 25 wt % of the reinforced fiber in a discontinuous phase form, based on the total weight of the reinforced fiber; and
wherein the reinforced fiber is selected from the group consisting of glass fiber, basalt fiber, carbon fiber, and natural fiber.

31. The process according to claim 30, wherein the reinforced fiber in a discontinuous phase form in step 4) is obtained by chopping long fibers on site, and is added into the mixture of the isocyanate component and the polyol component of polyurethane in a constant rate, and the chopped reinforced fiber has a length of 6 to 100 mm.

32. The process according to claim 30, wherein the reinforced fiber in a continuous phase form in step 1) is in a form of mat, woven fabrics, or combinations thereof.

33. A covering article suitable for a battery system, comprising the laminated product according to claim 19.
